(19) United States
(12) Patent Application Publication
(10) Pub. No.: US 2024/0220697 A1
(43) Pub. Date: Jul. 4, 2024

(54) AUTOMATED DESIGN-TO-LITHOGRAPHY AND DESIGN CHECKING FOR STITCHED INTEGRATED CIRCUIT DESIGN

(71) Applicant: International Business Machines Corporation, Armonk, NY (US)

(72) Inventors: DONGBING SHAO, Briarcliff Manor, NY (US); April Carniol, Ossining, NY (US); Jyotica Patel, Yonkers, NY (US); Michael Justin Beckley, New York, NY (US); James R. Brancaccio, Florida, NY (US)

(21) Appl. No.: 18/092,130

(22) Filed: Dec. 30, 2022

(51) Int. Cl. G06F 30/392; G06F 30/398

(52) U.S. Cl. CPC G06F 30/392; G06F 30/398

(57) ABSTRACT

An integrated circuit design is partitioned into a plurality of cells and a plurality of images of a stitched chip design are generated based on the plurality of cells. At least one of the images is wrapped with a chrome border and a blading outline to generate a mask design. Design information is extracted from the mask design and the stitched chip design. A scanner job file for fabricating the integrated circuit design is generated based on the extracted design information and the fabrication of an integrated circuit using the scanner job file is facilitated.

### BACKGROUND

The present invention relates generally to the electrical, electronic and computer arts and, more particularly, to integrated circuit design and manufacturing.

A trend towards large integrated circuits (ICs) has been experienced in circuit design, principally for artificial intelligence (AI)/Quantum systems. For example, the size of some ICs is often larger than the exposure field of conventional lithography tool scanners. Wafer scale engines (central processors for deep learning computer systems) on the order of 8.5 inches×8.5 inches (21.6 cm×21.6 cm) have been implemented with a claim of being the largest semiconductor chip ever fabricated. Quantum roadmaps to 1000 quantum bits (qubits) have been proposed. The qubit size, however, cannot be shrunk significantly without impacting performance. Thus, larger integrated circuits are a pertinent trend of circuit design.

### BRIEF SUMMARY

Principles of the invention provide techniques for automated design-to-lithography and design checking for stitched integrated circuit design. In one aspect, an exemplary method includes the steps of partitioning an integrated circuit design into a plurality of cells; generating a plurality of images of a stitched chip design based on the plurality of cells; wrapping at least one of the images with a chrome border and a blading outline to generate a mask design; extracting design information from the mask design and the stitched chip design; generating a scanner job file embodying the integrated circuit design based on the extracted design information; and facilitating fabrication of an integrated circuit using the scanner job file.

In one aspect, an exemplary method includes the steps of partitioning an integrated circuit design into a set of cells; generating a set of images of a stitched chip design based on the set of cells; wrapping at least one of the images with a chrome border and a blading outline to generate a mask design; extracting active design information from the mask design and the stitched chip design; generating a reconstructed chip design based on the active design information extracted from the mask design and the stitched chip design; comparing the reconstructed chip design and the integrated circuit design; reporting one or more errors detected by the comparing operation; and generating a different set of images that mitigate the reported one or more errors.

In another aspect, an exemplary apparatus includes a memory; and at least one processor, coupled to the memory, and operative to perform or otherwise facilitate any one, some, or all of the method steps/operations described herein.

As used herein, “facilitating” an action includes performing the action, making the action easier, helping to carry the action out, or causing the action to be performed. Thus, by way of example and not limitation, instructions executing on a processor might facilitate an action carried out by semiconductor fabrication equipment, by sending appropriate data or commands to cause or aid the action to be performed. Where an actor facilitates an action by other than performing the action, the action is nevertheless performed by some entity or combination of entities.

Techniques as disclosed herein can provide substantial beneficial technical effects. Some embodiments may not have these potential advantages and these potential advantages are not necessarily required of all embodiments. By way of example only and without limitation, one or more embodiments may provide one or more of:
enablement of the design and manufacture of large integrated circuits;
enablement of stitched integrated circuit design and manufacture;
improves the speed of designing and verifying large integrated circuits;
improves the speed of configuring lithographic scanners;
reduces errors in configuring lithographic scanners; and
a design process that enables large chip design for sub-reticle stitching.

These and other features and advantages will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1A shows a comparison of standard mask exposure and bladed and stitched exposure, in accordance with an example embodiment;

FIG. 1B shows a comparison of standard mask exposure for multi-patterning and bladed and stitched exposure, in accordance with an example embodiment;

FIG. 2A shows the conventional optics in a lithography scanner;

FIG. 2B shows a graph of the gradual change in intensity caused by the Penumbra effect of the edge of the blade;

FIG. 3A illustrates a conventional standard mask exposure on a wafer;

FIG. 3B illustrates a mask exposure on the wafer using the bladed and stitched exposure technique, in accordance with an example embodiment;

FIG. 4 illustrates the relationship of mask designs and chip designs, in accordance with an example embodiment;

FIG. 5 illustrates the relationships of the images, the chrome borders, and the blading outlines, in accordance with an example embodiment;

FIG. 6 is a block diagram and workflow for an example method for design checking and a design-to-lithographic task, in accordance with an example embodiment;

FIG. 7 is a diagram of an integrated circuit design hierarchy, in accordance with an example embodiment;

FIG. 8 depicts a computing environment according to an embodiment of the present invention;

FIG. 9 is a flow diagram of a design process used in semiconductor design, manufacture, and/or test;

FIG. 10 shows further aspects of IC fabrication from physical design data; and

FIG. 11 shows an exemplary high-level Electronic Design Automation (EDA) tool flow, within which aspects of the invention can be employed.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION

Principles of inventions described herein will be in the context of illustrative embodiments. Moreover, it will become apparent to those skilled in the art given the teachings herein that numerous modifications can be made to the embodiments shown that are within the scope of the claims. That is, no limitations with respect to the embodiments shown and described herein are intended or should be inferred.

### Approaches to Large Integrated Circuits

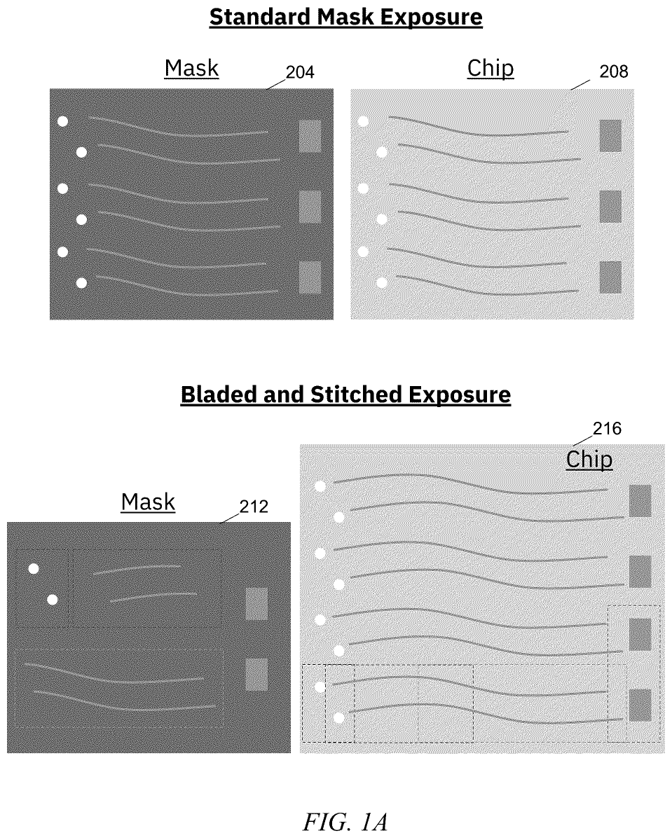

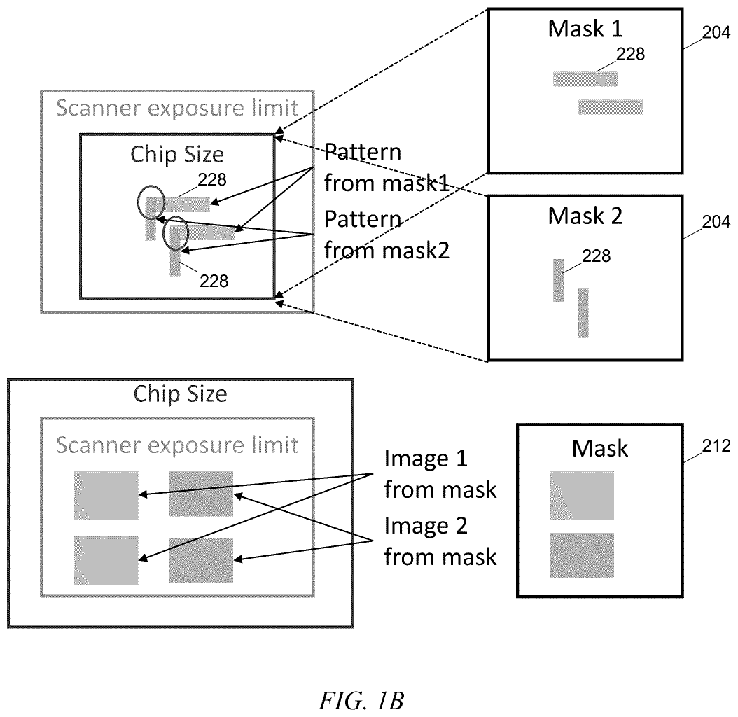

Generally, techniques and systems for stitched integrated circuit design and manufacture are disclosed. Stitched integrated circuit designs produce large integrated circuits (also referred to as chips and ICs herein) by partitioning a large chip design into smaller units that are stitched together by multiple exposures of one or more masks on a wafer. FIG. 1A shows a comparison of standard mask exposure and bladed and stitched exposure, in accordance with an example embodiment. While the mask 204 of the standard mask exposure contains the design of the entire chip 208, the mask 212 of the bladed and stitched exposure technique contains only a portion of the entire chip 216 and requires multiple exposures of one or more masks 212 to fully expose the chip 216. (It is noted that, in some instances, the pattern of the chip 216 is based on replicating portions of the mask 212 through successive exposures. In this case, it is possible that only mask 212 is required for the exposure of the entire chip 216.)

### Difference to Multi-Patterning

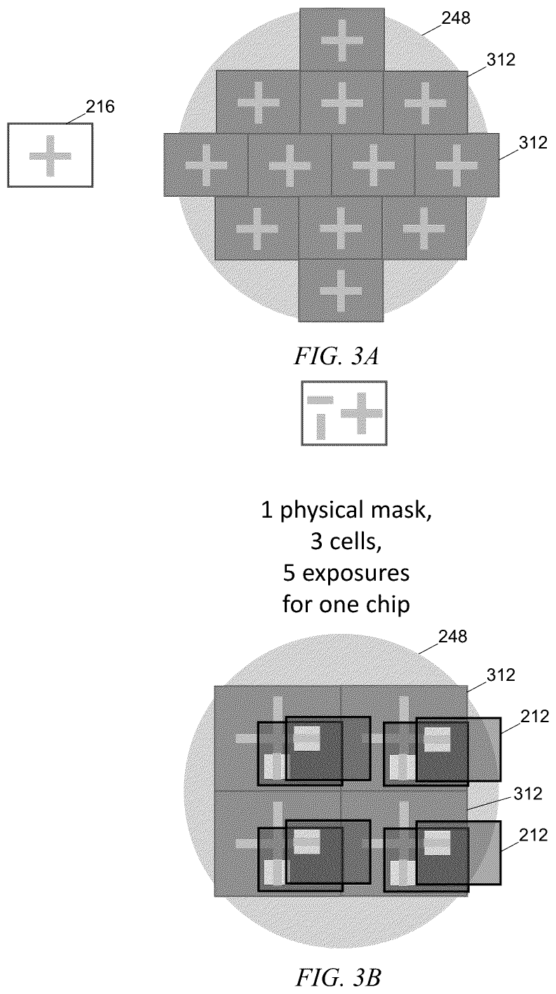

FIG. 1B shows a comparison of standard mask exposure for multi-patterning and bladed and stitched exposure, in accordance with an example embodiment. In multi-patterning (top technique), components 228 of a mask 204 are overlayed on components 228 of a mask 204 (the same mask 204 or a different mask 204) on a different layer. In stitching, images on a wafer 248 (see FIGS. 3A and 3B) are created using different exposures, but the images are stitched together, side-by-side, to create a unified circuit.

### Scanner Exposure Field Limit

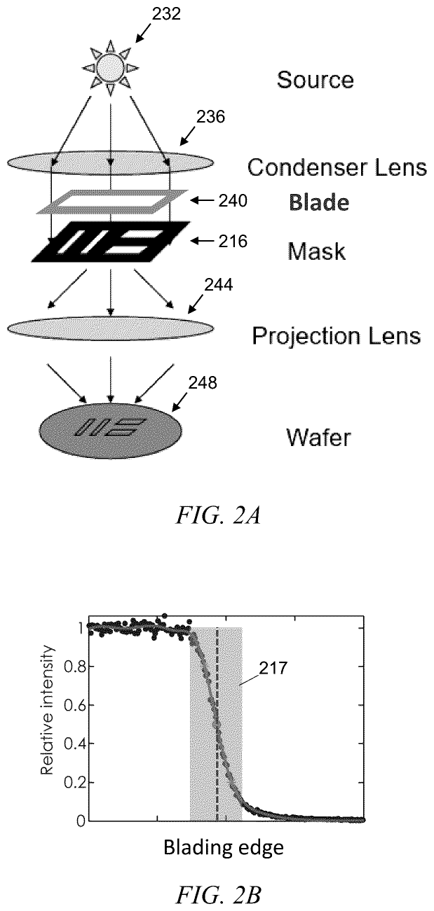

Conventional reticle sizes for IC manufacture include 22 millimeter (mm)×27.4 mm for a 248 nm scanner, 26 mm×32 mm for a 193 nm scanner, 26 mm×33 mm for EUV, 26 mm×16.5 mm for High numerical aperture (NA) extreme ultraviolet (EUV), and the like (where 248 nm and 193 nm refer to the wavelength of light supported by the corresponding scanner, for lithography). FIG. 2A shows the conventional optics in a lithography scanner. A light source 232 emits light that is focused by a condenser lens 236. The focused light is masked by both blade 240 and mask 216, and then projected via projection lens 244 onto a wafer 248. Due to the penumbra effect, the light bypassing the edge of the blade 240 suffers from a decay in intensity. Note that images can be kept away from the edges of the blade to avoid distortion. FIG. 2B shows a graph of the gradual change in intensity caused by the Penumbra effect of the edge of the blade 240. The decay region 217 is typically on the order of a couple hundred microns in width. In some cases, the decay region is on the order of 700-1,000 microns. Due to the Penumbra effect, the actual edges of the chip design on a mask 216 need to be kept away from the edge of the blade 240 of the scanner. There is therefore no clear boundary for stitching. Conventionally, a great amount of engineering work is needed to address the penumbra effect.

### Stitched Designs: Lithographic Changes

FIG. 3A illustrates a conventional standard mask exposure on a wafer 248. A mask 216 corresponds to one IC and is exposed to different areas of the wafer 248 to create multiple ICs 312.

FIG. 3B illustrates a mask exposure on the wafer 248 using the bladed and stitched exposure technique, in accordance with an example embodiment. The mask 212 contains one or more images that are exposed (and possibly replicated) on the wafer 248 for each IC 312 on the wafer 248. Note that sub reticle stitching can work with multiple images on a mask. Blade is used to select which image to do exposure. Of course there are restrictions on how many images can be placed on a mask Several images must be stepped through by the scanner to complete the exposure for one IC 312 while meeting the design requirements for stitching the individual images together. It is noted that, in some circumstances, a plurality of masks 212 are required to complete exposure of the wafer 248. Thus, the design is no longer “what you see (on the mask) is what you get (on the wafer).” In some instances, M images on N masks 212 are used to form one chip design, where one image can be repeated multiple times on a single chip design. Essentially, the scanner is no longer considered a simple “stepper.” Moreover, it is noted that manually setting up wafer exposure is often a tedious and error-prone task.

### Stitched Design: Design Solution

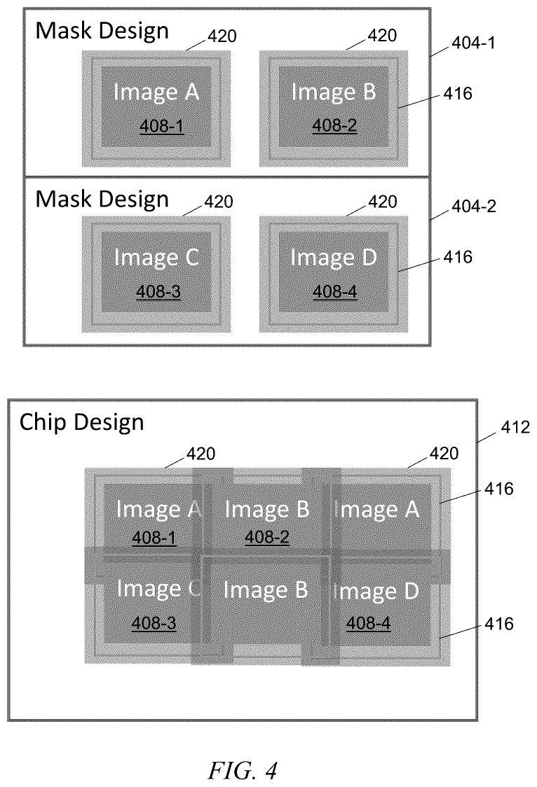

FIG. 4 illustrates the relationship of mask designs and chip designs, in accordance with an example embodiment. In one example embodiment, each mask design 404-1, 404-2 includes one or more images 408-1, 408-2, 408-3, 408-4. A chip design 412 designates the layout of the images 408-1, 408-2, 408-3, 408-4 on the wafer 248.

Both the mask designs 404-1, 404-2 and the chip design 412 contain cells defined by an individual image 408-1, 408-2, 408-3, 408-4. Each individual image 408-1, 408-2, 408-3, 408-4 (also referred to as image cells 408-1, 408-2, 408-3, 408-4 herein) includes a blading outline 416 (also referred to as a blading 416 herein) and a chrome border 420. The chrome border 420 blocks light from a neighboring image 408-1, 408-2, 408-3, 408-4 from interfering with other images 408-1, 408-2, 408-3, 408-4 exposed on the wafer 248. By using the appropriate settings of the scanner for the blading outlines 416 and the configuration of the mask design 404-1, 404-2 for the chrome borders 420, seamless stitching can be achieved. Configuring the lithography of the scanner, however, can be a big challenge as the placement of the image 408-1, 408-2, 408-3, 408-4 on the wafer 248, the blade size and settings in the scanner, and the placement of the chrome border 420 on the mask design 404-1, 404-2 are significant. It is noted that the chrome border 420 is used in one or more embodiments to block the area effected by the penumbra from being exposed on the wafer 248. These tasks are typically done manually, and therefore tend to be error-prone. In one example embodiment, the information in the mask designs 404-1, 404-2 and the chip design 412 is extracted and the scanner job file is automatically generated.

It is noted that the stepper accuracy of a conventional scanner is approximately 15 nm. As there is usually under-exposure at the borders of the images 408-1, 408-2, 408-3, 408-4, an overlap of approximately 150 nm (plus or minus, for example, 50 nm) between two neighboring images 408-1, 408-2, 408-3, 408-4 is used in one or more embodiments to achieve a normal exposure on the wafer 248 without creating an overexposure. Conventional techniques utilize a sacrificial area (unused area) between two neighboring images 408-1, 408-2, 408-3, 408-4 when separate exposures on the chip are performed.

### Examples of Scanner Job Files

Two example scanner job files were analyzed: a first file included 3,000+ lines and 450 (12 unique) sections; and a second file included 21,000+ lines and 3,000 (same 12 unique) sections (information was defined in sections and cross-referenced between the sections). Other than design information, the following were also considered:
scanner tool settings;
exposure of multiple levels, including the front and back of the wafer 248; and
hidden integration information, such as alignment sequences.

It should be noted that the skilled artisan will have general familiarity with lithography job files associated with lithography tools and the like.

### Design-to-Lithography Tool

In one example embodiment, a design-to-lithography tool extracts the information in the mask designs 404-1, 404-2 and the chip design 412, and automatically generates the scanner job file for configuring a scanner to support stitched chip designs. The design-to-lithography tool provides techniques for automated design-to-lithography and design checking for stitched integrated circuit design that goes beyond the scanner tool exposure field limit. Information such as the cell center location of each image 408-1, 408-2, 408-3, 408-4 on the mask design 404-1, 404-2, the cell blading width and height information of each image 408-1, 408-2, 408-3, 408-4, and the like is extracted from the mask designs 404-1, 404-2.

Information such as the cell center location on the chip design 412 (which image 408-1, 408-2, 408-3, 408-4 is used and where to place on the wafer 248 in FIG. 2A) of each image 408-1, 408-2, 408-3, 408-4, total chip width and height information (used for scanner stepping), and the like is extracted from the chip design 412.

The chip placement on the wafer 248 and the alignment information (such as the location, the tone, the x or y alignment, the associated layer, and the like) are extracted from the wafer design. A wafer map is generated based on the wafer size, chip width and height, and the like.

A scanner job file that is compatible with the target lithographic scanner is generated by the design-to-lithography tool. The scanner job file defines, for example, the reticle information, the chip size (x/y dimensions), the chip shift (x/y dimensions), the size of each image 408-1, 408-2, 408-3, 408-4, the shift of each image 408-1, 408-2, 408-3, 408-4, entities on chip: image identifier, and the entity placement on the wafer 248 based on the wafer map.

### Design Checking for Stitched Design

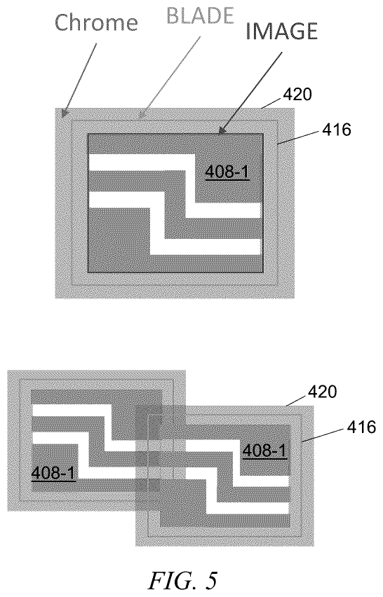

FIG. 5 illustrates the relationships of the images 408-1, 408-2, 408-3, 408-4, the chrome borders 420, and the blading outlines 416, in accordance with an example embodiment. As illustrated in FIG. 5, the blading outline 416 is typically a rectangle with a size limited by the target scanner and is positioned in the center of the corresponding chrome border 420. It is noted that it is easier to design/check the image 408-1, 408-2, 408-3, 408-4 and generate the chrome border 420 from the blading outline 416 and the corresponding image 408-1, 408-2, 408-3, 408-4, as the images 408-1, 408-2, 408-3, 408-4 and blading 416 are generally squares or rectangles versus the border shape of the chrome border 420. Examples of pertinent design rules include the following:
images 408-1, 408-2, 408-3, 408-4 on one mask are constrained by a mask size limit;
blading outline 416 should typically be an orthogonal rectangle with horizontal/vertical minimum/maximum dimensions;
image distance within the blading outline 416 (distance from edge of the image 408-1, 408-2, 408-3, 408-4 to edge of the blading outline 416 when projected in two dimensions);
distance between two images 408-1, 408-2, 408-3, 408-4; and
no overlap or gap of the image 408-1, 408-2, 408-3, 408-4 on the chip/wafer 248 (excludes the overlap implemented to mitigate the underexposure at the borders of the images 408-1, 408-2, 408-3, 408-4).

It is noted that it is difficult to perform this, if not impossible, in conventional design rule checking (DRC) due to design flattening in DRC. Also, note that in one or more embodiments, there is no gap/overlap between adjacent images, but the blade shapes will be overlapped.

### Overall Process

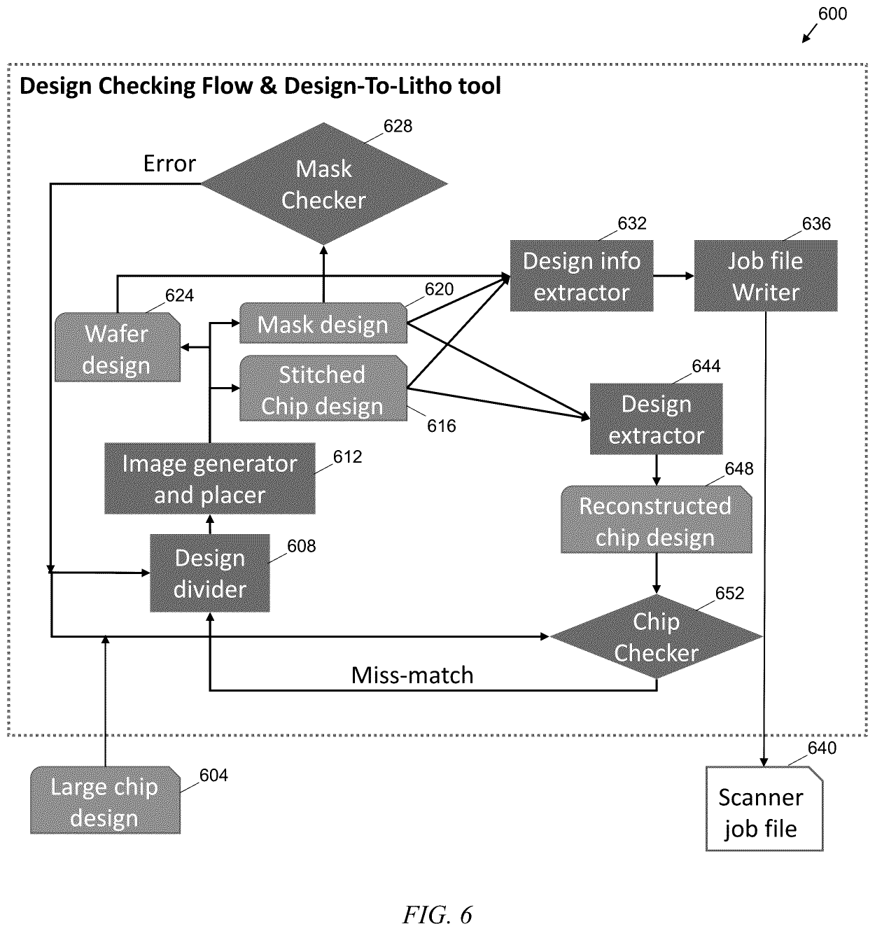

FIG. 6 is a block diagram and workflow for an example method 600 for design checking and a design-to-lithographic task, in accordance with an example embodiment. The system/flow 600 is an electronic design automation (EDA) system that enables large chip design and fabrication. The output is a mask design 620 and scanner job file 640. In one example embodiment, a large chip design 604 is partitioned by a design divider 608. The partitioning may be performed manually, automatically, or semi-automatically and may start from a high-level cell and proceed down through the hierarchy. For example, the design divider 608 may provide a list of cells and the user selects which cells are to be partitioned. In one example embodiment, a user provides a threshold size and the design divider 608 automatically divides cells larger than the threshold. A user could provide other rules, such as instructing the design divider 608 to identify repeated circuits and to partition the cells based on the repeated circuits; that is, the design divider 608 considers whether images 408-1, 408-2, 408-3, 408-4 are repeated in the stitched chip design 616. Each partition (also referred to as a cell herein) is processed by an image generator and placer 612 to generate a corresponding image 408-1, 408-2, 408-3, 408-4. If a unit cell is a polygon, the image generator and placer 612 finds a rectangle that is larger than the polygon and wraps the image and blade marker with a border based on the larger rectangle (distinguished from the chrome border 420). The image generator and placer 612 then places, manually, automatically, or semi-automatically, the image 408-1, 408-2, 408-3, 408-4 onto the mask design 620, the wafer design 624, and the stitched chip design 616.

The images 408-1, 408-2, 408-3, 408-4, together, thus form a stitched chip design 616 which should match, logic-wise and circuitry-wise, the large chip design 604. The images 408-1, 408-2, 408-3, 408-4 are used to produce one or more mask designs 620, and the mask designs 620 are used to create a wafer design 624 which defines the relationship of the mask designs 620 on the wafer 248. As the mask designs 620 are generated, a mask checker 628 verifies that the mask designs 620 satisfy the design rules for masks in the context of the target scanner. In one example embodiment, the mask checker 628 is a conventional mask checker that runs a design rule checker (DRC), modified to support the disclosed techniques. For example, two image markers may unintentionally overlap and create a polygon instead of two rectangles after design flattening during DRC. The modified DRC in mask checker will flag this as an error which can, for example, be manually corrected.

The mask designs 620 and the stitched chip design 616 are processed by a design information extractor 632, which extracts the information needed to automatically generate a scanner job file 640. The job file writer 636 uses the extracted information to generate the scanner job file 640. In general, the job file writer 636 takes input from the design information extractor 632 and reformats the information based on the requirements of the scanner.

To ensure that the mask designs 620 and the stitched chip design 616 accurately reflect the original large chip design 604, a design check is performed. A design extractor 644 processes the mask designs 620 and the stitched chip design 616 to generate a reconstructed chip design 648. (In one example embodiment, the design information extractor 632 and the design extractor 644 are conventional design extractors.) The reconstructed chip design 648 is compared to the large chip design 604 by a chip checker 652. Any mismatch or other error is reported. In one example embodiment, the report of a mismatch or other error triggers a mitigation action. For example, in response to an error, a re-division of the large chip design 604 may be performed. The mitigation action is dependent on the type of error that is reported and may be performed manually, automatically, or semi-automatically. In one example embodiment, the design divider 608, the image generator 612, the mask checker 628, the design information extractor 632, the job file writer 636, the design extractor 644, and the chip checker 652 are implemented with software running on a corresponding digital processor of a digital processor circuit.

In one or more embodiments, errors are handed based on the nature of the error, and the rule requirements. For example, the error triggers going back to the beginning of flow but the error may be fixed without need of re-dividing the design. In other words, the flow can go back to the “design divider” but changes only happen where the mask or chip design is created.

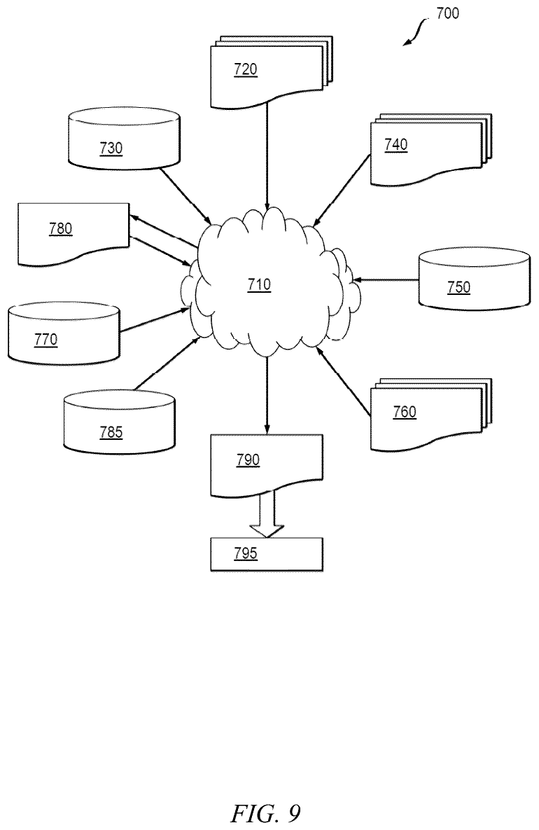

In FIG. 6, the designs 604, 624, 620, 616, and 648; and the job file 640 can be instantiated in appropriate data structures. The design divider 608, image generator 612, mask checker 628, design information extractor 632, job file writer 636, design extractor 644, and chip checker 652 can be implemented, in software on a general-purpose computer, using logic as set forth herein and adapting known EDA tools, design verification tools, lithography tools, and the like, based on the teachings herein. See, e.g., FIGS. 9-11 below.

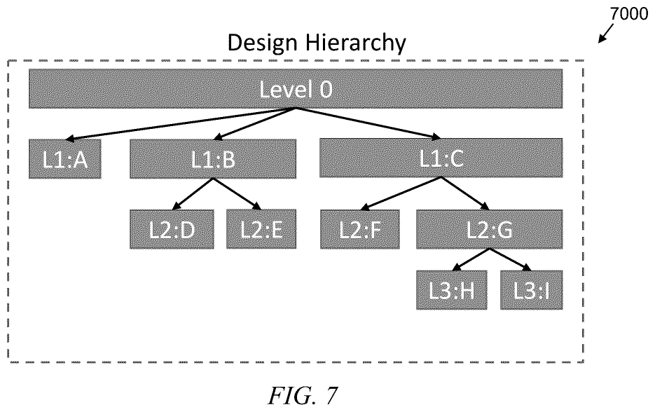

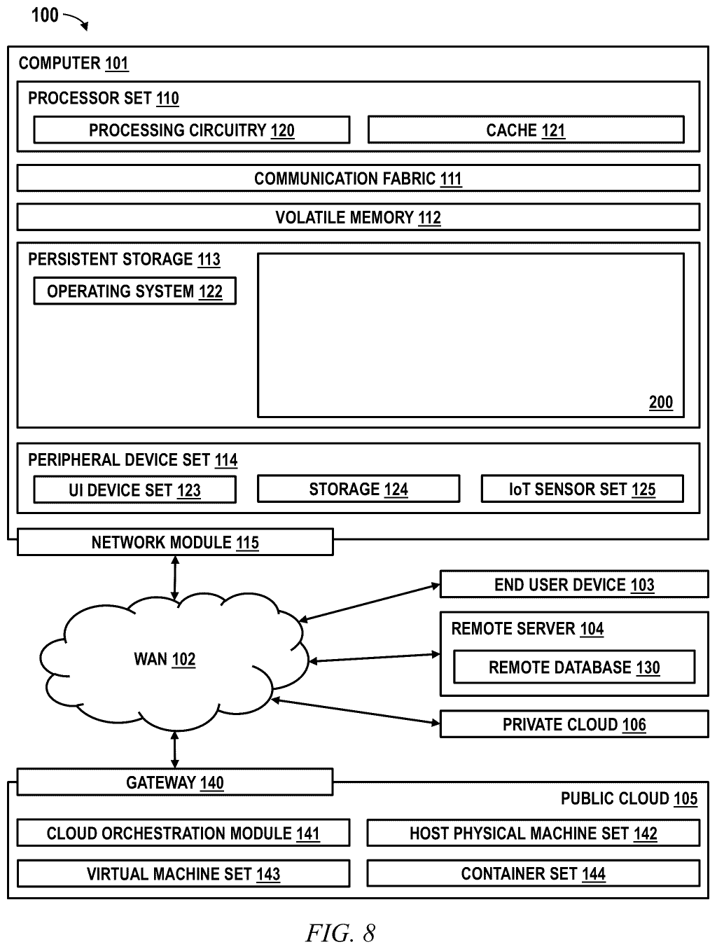

FIG. 7 is a diagram of an integrated circuit design hierarchy 7000, in accordance with an example embodiment. In one or more embodiments, the design dividing step goes through hierarchy level(s), and the final cells to use for images depend on the cell sizes and the repetition of cells. The final choice of images can be a mix of cells from different hierarchy levels. For example, the user could start with cell A/B/C, but end up with cell A/D/E/F/G or even A/D/E/F/H/I. The dividing can be more complicated than what is shown; for example, there may be a cell C* that partially overlaps with cell C at the L1 level. If the user decides to further divide cell C into cells F and G, for whatever reason, then cell C* must be divided accordingly, resulting in a design crossing boundar(ies) of images. For complex designs, this dividing step can be tricky and that is why one or more embodiments compare the stitched design and the original design in the end at step 652.

### Modules in Design-to-Lithography Flow

In one example embodiment, a design-to-lithography tool includes:
the design divider 608: divides, for example, high-level cells by sub-cell regrouping (in one or more embodiments, the design crossing the division is only at the higher metal levels);
the image generator and placer 612: adds BLADE/IMAGE marker (which, for example, indicates the relationship between the corresponding image 408-1, 408-2, 408-3, 408-4 and the blading 416, optical proximity correction (OPC) on the design within each image 408-1, 408-2, 408-3, 408-4 (includes conventional image distortion and image correction considerations, and special OPC at the image borders), adding the chrome borders 420 based on the blading outline 416 and the image 408-1, 408-2, 408-3, 408-4 (at image or cell level; if a chip design crosses an image boundary, special correction may be needed (depending on line-width & local proximity effect)), and generating the mask design 620, the stitched chip design 616 and a wafer design 624;
the mask checker 628: checks, for example, rules related to the mask design 620, the blading outline 416, and the image 408-1, 408-2, 408-3, 408-4;
the design extractor 644: extracts, for example, an active design from the stitched chip design 616;
the chip checker 652: compares the original large chip design 604 and the reconstructed chip design 648 to make sure there is no overlap/gap of images (distinguished from the chrome border 420 and repeated for key layers in the large chip design 604);
the design information extractor 632: extracts, for example, the blading size and location on mask designs 620, the blading outline 416 location on the chip, chip placement on the wafer 248, alignment information on the wafer 248, and the like; and
the job file writer 636: constructs, for example, the scanner job file 640 based on the scanner file format of the target scanner and the extracted design information.

It is worth noting that one or more embodiments can work with design files; can directly take chip design layout as input; and/or can carry out design checking. Moreover, one or more embodiments incorporate the blading 416 and the chrome border 420 into the design, require no boundary region nor change to the incoming design, support a flexible image size, provide mask design checking with respect to the blading 416 and the chrome border 420, and/or automate the design-to-lithography flow.

### Design Checking

In one example embodiment, overall design checking is performed to make sure the stitched chip design 616 matches the large chip design 604. The active design (that is, logic and other circuitry, as distinguished from, for example, a ground plane) is extracted from each image 408-1, 408-2, 408-3, 408-4 on the mask design(s) 620 and each active design is placed according to the cell placement in the stitched chip design 616 to reconstruct the original chip (the reconstructed chip design 648). The reconstructed chip design 648 is compared with the original large chip design 604.

Design checking between two image 408-1, 408-2, 408-3, 408-4 that overlap in the chip design is performed by extracting the design from cell CA and copying it to layer set LA, extracting the design from cell CB and copying it to layer set LB, placing the two sets of designs according to their original placement in a temporary cell, and running rule checking.

Given the discussion thus far, it will be appreciated that, in general terms, an exemplary method, according to an aspect of the invention, includes the steps of partitioning an integrated circuit design 604 into a plurality of cells; generating a plurality of images 408-1, 408-2, 408-3, 408-4 of a stitched chip design 616 based on the plurality of cells; and wrapping at least one of the images 408-1, 408-2, 408-3, 408-4 with a chrome border 420 and a blading outline 416 to generate a mask design 620. The method further includes extracting design information from the mask design 620 and the stitched chip design 616; generating a scanner job file 640 embodying (i.e., can be used for fabricating) the integrated circuit design 604 based on the extracted design information; and facilitating fabrication of an integrated circuit using the scanner job file 640.

In some instances, the chrome border 420 is configured to block an area of on a wafer 248 from light exposure of a corresponding mask design 620, wherein the blocked area is effected by a penumbra effect generated by the blading outline 416.

In one or more embodiments, exposures on a wafer 248 of two images 408-1, 408-2, 408-3, 408-4 are configured to partially overlap.

Some instances further include generating a reconstructed chip design 648 based on information extracted from the mask design 620 and the stitched chip design 616; and comparing the reconstructed chip design 648 and the integrated circuit design 604.

One or more embodiments further include repeating the partitioning of the integrated circuit design 604 into a plurality of different cells.

Some instances further include performing design rule checking on the mask design 620.

Facilitating fabrication of the integrated circuit can include, for example, providing a design structure as described elsewhere herein to a foundry (e.g., over a WAN 102 discussed elsewhere herein).

In another aspect, facilitating fabrication of the integrated circuit can include, for example, actually fabricating the integrated circuit in physical form.

In another aspect, another exemplary method includes partitioning an integrated circuit design 604 into a set of cells; generating a set of images 408-1, 408-2, 408-3, 408-4 of a stitched chip design 616 based on the set of cells; and wrapping at least one of the images 408-1, 408-2, 408-3, 408-4 with a chrome border 420 and a blading outline 416 to generate a mask design 620. The method further includes extracting active design information from the mask design 620 and the stitched chip design 616; generating a reconstructed chip design 648 based on the active design information extracted from the mask design 620 and the stitched chip design 616; and comparing the reconstructed chip design 648 and the integrated circuit design 604. The method even further includes reporting one or more errors detected by the comparing operation; and generating a different set of images 408-1, 408-2, 408-3, 408-4 that mitigate the reported one or more errors.

One or more embodiments further include repartitioning the integrated circuit design 604 into a different set of cells.

One or more embodiments further include facilitating fabrication (as discussed elsewhere herein) of an integrated circuit based on the different set of images 408-1, 408-2, 408-3, 408-4.

In another aspect, an exemplary apparatus includes a memory; and at least one processor, coupled to the memory, and operative to perform or otherwise facilitate any one, some, or all of the method steps/operations described herein.

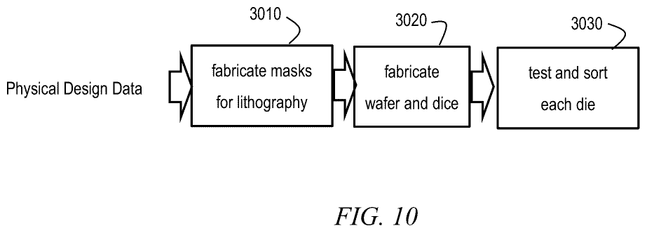

Once the exemplary processes described herein are carried out, an integrated circuit designed in accordance therewith can be fabricated according to otherwise known processes that are generally described with reference to FIG. 10. Generally, a wafer with multiple copies of the final design is fabricated and cut (i.e., diced) such that each die is one copy of the integrated circuit. At block 3010, the processes include fabricating masks for lithography based on the finalized physical layout (according to aspects described herein). At block 3020, fabricating the wafer includes using the masks to perform photolithography and etching. Once the wafer is diced, testing and sorting each die is performed at 3030 to filter out any faulty die.

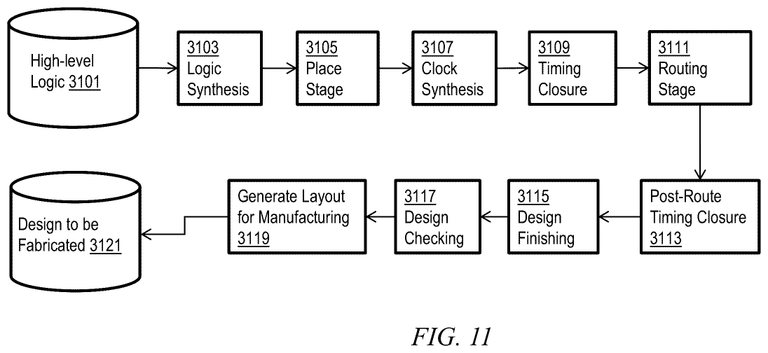

FIG. 11 depicts an example high-level Electronic Design Automation (EDA) tool flow, which is responsible for creating an optimized microprocessor (or other IC) design to be manufactured. A designer could start with a high-level logic description 3101 of the circuit (e.g. VHDL or Verilog). The logic synthesis tool 3103 compiles the logic, and optimizes it without any sense of its physical representation, and with estimated timing information. The placement tool 3105 takes the logical description and places each component, looking to minimize congestion in each area of the design. The clock synthesis tool 3107 optimizes the clock tree network by cloning/balancing/buffering the latches or registers. The timing closure step 3109 performs a number of optimizations on the design, including buffering, wire tuning, and circuit repowering; its goal is to produce a design which is routable, without timing violations, and without excess power consumption. The routing stage 3111 takes the placed/optimized design, and determines how to create wires to connect all of the components, without causing manufacturing violations. Post-route timing closure 3113 performs another set of optimizations to resolve any violations that are remaining after the routing. Design finishing 3115 then adds extra metal shapes to the netlist, to conform with manufacturing requirements. The checking steps 3117 analyze whether the design is violating any requirements such as manufacturing, timing, power, electromigration (e.g., using techniques disclosed herein) or noise. When the design is clean, the final step 3119 is to generate a layout for the design, representing all the shapes to be fabricated in the design to be fabricated 3121.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a design-to-lithography tool 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Exemplary Design Process Used in Semiconductor Design, Manufacture, and/or Test

One or more embodiments integrate the characterizing and simulating techniques herein with semiconductor integrated circuit design simulation, test, layout, and/or manufacture. In this regard, FIG. 9 shows a block diagram of an exemplary design flow 700 used for example, in semiconductor IC logic design, simulation, test, layout, and manufacture. Design flow 700 includes processes, machines and/or mechanisms for processing design structures or devices to generate logically or otherwise functionally equivalent representations of design structures and/or devices, such as those that can be analyzed using techniques disclosed herein or the like. The design structures processed and/or generated by design flow 700 may be encoded on machine-readable storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 700 may vary depending on the type of representation being designed. For example, a design flow 700 for building an application specific IC (ASIC) may differ from a design flow 700 for designing a standard component or from a design flow 700 for instantiating the design into a programmable array, for example a programmable gate array (PGA) or a field programmable gate array (FPGA) offered by Altera® Inc. or Xilinx® Inc.

FIG. 9 illustrates multiple such design structures including an input design structure 720 that is preferably processed by a design process 710. Design structure 720 may be a logical simulation design structure generated and processed by design process 710 to produce a logically equivalent functional representation of a hardware device. Design structure 720 may also or alternatively comprise data and/or program instructions that when processed by design process 710, generate a functional representation of the physical structure of a hardware device. Whether representing functional and/or structural design features, design structure 720 may be generated using electronic computer-aided design (ECAD) such as implemented by a core developer/designer. When encoded on a gate array or storage medium or the like, design structure 720 may be accessed and processed by one or more hardware and/or software modules within design process 710 to simulate or otherwise functionally represent an electronic component, circuit, electronic or logic module, apparatus, device, or system. As such, design structure 720 may comprise files or other data structures including human and/or machine-readable source code, compiled structures, and computer executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher level design languages such as C or C++.

Design process 710 preferably employs and incorporates hardware and/or software modules for synthesizing, translating, or otherwise processing a design/simulation functional equivalent of components, circuits, devices, or logic structures to generate a Netlist 780 which may contain design structures such as design structure 720. Netlist 780 may comprise, for example, compiled or otherwise processed data structures representing a list of wires, discrete components, logic gates, control circuits, I/O devices, models, etc. that describes the connections to other elements and circuits in an integrated circuit design. Netlist 780 may be synthesized using an iterative process in which netlist 780 is resynthesized one or more times depending on design specifications and parameters for the device. As with other design structure types described herein, netlist 780 may be recorded on a machine-readable data storage medium or programmed into a programmable gate array. The medium may be a nonvolatile storage medium such as a magnetic or optical disk drive, a programmable gate array, a compact flash, or other flash memory. Additionally, or in the alternative, the medium may be a system or cache memory, buffer space, or other suitable memory.

Design process 710 may include hardware and software modules for processing a variety of input data structure types including Netlist 780. Such data structure types may reside, for example, within library elements 730 and include a set of commonly used elements, circuits, and devices, including models, layouts, and symbolic representations, for a given manufacturing technology (e.g., different technology nodes, 32 nm, 45 nm, 90 nm, etc.). The data structure types may further include design specifications 740, characterization data 750, verification data 760, design rules 770, and test data files 785 which may include input test patterns, output test results, and other testing information. Design process 710 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 710 without deviating from the scope and spirit of the invention. Design process 710 may also include modules for performing standard circuit design processes such as timing analysis, verification, design rule checking, place and route operations, etc. Improved latch tree synthesis can be performed as described herein.

Design process 710 employs and incorporates logic and physical design tools such as HDL compilers and simulation model build tools to process design structure 720 together with some or all of the depicted supporting data structures along with any additional mechanical design or data (if applicable), to generate a second design structure 790. Design structure 790 resides on a storage medium or programmable gate array in a data format used for the exchange of data of mechanical devices and structures (e.g. information stored in an IGES, DXF, Parasolid XT, JT, DRG, or any other suitable format for storing or rendering such mechanical design structures). Similar to design structure 720, design structure 790 preferably comprises one or more files, data structures, or other computer-encoded data or instructions that reside on data storage media and that when processed by an ECAD system generate a logically or otherwise functionally equivalent form of one or more IC designs or the like. In one embodiment, design structure 790 may comprise a compiled, executable HDL simulation model that functionally simulates the devices to be analyzed.

Design structure 790 may also employ a data format used for the exchange of layout data of integrated circuits and/or symbolic data format (e.g. information stored in a GDSII (GDS2), GL1, OASIS, map files, or any other suitable format for storing such design data structures). Design structure 790 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described herein (e.g., .lib files). Design structure 790 may then proceed to a stage 795 where, for example, design structure 790: proceeds to tape-out, is released to manufacturing, is released to a mask house, is sent to another design house, is sent back to the customer, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
partitioning an integrated circuit design into a plurality of cells;
generating a plurality of images of a stitched chip design based on the plurality of cells;
wrapping at least one of the images with a chrome border and a blading outline to generate a mask design;
extracting design information from the mask design and the stitched chip design;
generating a scanner job file embodying the integrated circuit design based on the extracted design information; and
facilitating fabrication of an integrated circuit using the scanner job file.

2. The method of claim 1, wherein the chrome border is configured to block an area of on a wafer from light exposure of a corresponding mask design, wherein the blocked area is effected by a penumbra effect generated by the blading outline.

3. The method of claim 1, wherein exposures on a wafer of two images are configured to partially overlap.

4. The method of claim 1, further comprising:
generating a reconstructed chip design based on information extracted from the mask design and the stitched chip design; and
comparing the reconstructed chip design and the integrated circuit design.

5. The method of claim 4, further comprising repeating the partitioning of the integrated circuit design into a plurality of different cells.

6. The method of claim 1, further comprising performing design rule checking on the mask design.

7. The method of claim 1, wherein facilitating fabrication of the integrated circuit comprises providing a design structure to a foundry.

8. The method of claim 1, wherein facilitating fabrication of the integrated circuit comprises fabricating the integrated circuit in physical form.

9. A method comprising:
partitioning an integrated circuit design into a set of cells;
generating a set of images of a stitched chip design based on the set of cells;
wrapping at least one of the images with a chrome border and a blading outline to generate a mask design;
extracting active design information from the mask design and the stitched chip design;
generating a reconstructed chip design based on the active design information extracted from the mask design and the stitched chip design;
comparing the reconstructed chip design and the integrated circuit design;
reporting one or more errors detected by the comparing operation; and
generating a different set of images that mitigate the reported one or more errors.

10. The method of claim 9, further comprising repartitioning the integrated circuit design into a different set of cells.

11. The method of claim 9, further comprising facilitating fabrication of an integrated circuit based on the different set of images.

12. The method of claim 11, wherein facilitating fabrication of the integrated circuit comprises providing a design structure to a foundry.

13. The method of claim 11, wherein facilitating fabrication of the integrated circuit comprises fabricating the integrated circuit in physical form.

14. An apparatus comprising:
a memory; and
at least one processor, coupled to said memory, and operative to perform operations comprising:
partitioning an integrated circuit design into a plurality of cells;
generating a plurality of images of a stitched chip design based on the plurality of cells;
wrapping at least one of the images with a chrome border and a blading outline to generate a mask design;
extracting design information from the mask design and the stitched chip design;
generating a scanner job file for fabricating the integrated circuit design based on the extracted design information; and
facilitating fabrication of an integrated circuit using the scanner job file.

15. The apparatus of claim 14, wherein the chrome border is configured to block an area of on a wafer from light exposure of a corresponding mask design, wherein the blocked area is effected by a penumbra effect generated by the blading outline.

16. The apparatus of claim 14, wherein exposures on a wafer of two images are configured to partially overlap.

17. The apparatus of claim 14, wherein the at least one processor is further operative to perform operations comprising:
generating a reconstructed chip design based on information extracted from the mask design and the stitched chip design; and
comparing the reconstructed chip design and the integrated circuit design.

18. The apparatus of claim 17, wherein the at least one processor is further operative to repeat the partitioning of the integrated circuit design into a plurality of different cells.

19. The apparatus of claim 14, wherein the at least one processor is further operative to perform design rule checking on the mask design.

20. The apparatus of claim 14, wherein facilitating fabrication of the integrated circuit comprises the at least one processor controlling semiconductor fabrication equipment to fabricate the integrated circuit in physical form.
